(19) United States
(12) Patent Application Publication
(10) Pub. No.: US 2013/0075645 A1
(43) Pub. Date: Mar. 28, 2013

(54) T-SHAPED VALVE

(71) Applicant: CHIEN-TE HUNG, CHANGHWA (TW)

(72) Inventor: CHIEN-TE HUNG, CHANGHWA (TW)

(73) Assignee: KENT PLASTIC CO., LTD., CHANGHWA (TW)

(21) Appl. No.: 13/239,746

(22) Filed: Sep. 22, 2011

(51) Int. Cl. F16K 27/00

(52) U.S. Cl. 251/366

(57) ABSTRACT

A T-shaped valve includes an improved fitting structure is disclosed. A T-shaped valve has a connecting pipe and a branch pipe carrying a control valve. The connecting pipe has an inlet end provided with the fitting structure that includes a receiving section of the connecting pipe defining a receiving portion at the inlet end; an adapter having fixed to the receiving portion and peripherally formed with a flange; and a nut internally formed with a peripheral stepped section for retaining the flange such that the adapter is allowed to rotate with respect to the nut. The T-shaped valve in virtue of the improved fitting structure can be properly installed without repeated adjustment and reinstallation. Furthermore, components of the T-shaped valve are made of alternative material instead of lead-containing metal, so the T-shaped valve ensures water quality.

### BACKGROUND OF THE INVENTION

1. Technical Field

The present invention relates to valves, and more particularly to a T-shaped valve equipped with an improved fitting structure that facilitates installation, wherein components of the T-shaped valve are made of plastic instead of metal so as to prevent water flowing therethrough from metal contamination.

2. Description of Related Art

A T-shaped valve conventionally has a connecting pipe ended at two ends with a water inlet and a water outlet, respectively, and a valve portion extending perpendicular to and communicating with the connecting pipe so as to form a T-like shape of the integrated assembly. The water inlet and the water outlet are provided with either internal or external threads by which the water inlet and the water outlet can engage with a water source that supplies water and a extension pipe that leads the water to applications other than that connects the valve portion. In the most common case of installation of the T-shaped valve, the water inlet of the connecting pipe is screwed with a wall-fixed water source having matching threads. As usually required in connection of water pipe fittings, the wall-fixed water source, for example, having external threads for engaging the internal threads of the water inlet of the T-shaped valve, has to have the external threads first wound by tape seal, so that when the water inlet is screwed to the wall-fixed water source, the tape seal can ensure good connection between the wall-fixed water source and the connecting pipe without the risk of leakage. While the tape seal indeed he s to prevent leakage, it makes the length where the external threads of the wall-fixed water source receives the internal threads of the water inlet of the connecting pipe of the T-shaped valve uncontrollable. As a result, when the water inlet is assembled to the wall-fixed water source by rotating the entire T-shaped valve, the resultant location of the valve portion is relatively unpredictable. In other words, it is possible that the installed T-shaped valve has its valve switch rotated to an orientation where the operation of the valve portion is difficult or tends to be hindered by the water source and/or the connecting pipe, such as a place where the valve switch faces the ground. At this time, for adjusting the T-shaped valve to a proper orientation, the T-shaped valve has to be disassembled and the tape seal has to be rearranged prior to a next round of trail assembly, until the tape seal is such arranged that when the water inlet is fully screwed to the water source, the switch of the T-shaped valve is at an orientation allowing convenient operation. Such repeated installation and adjustment waste both time and energy significantly.

On the other hand, the existing T-shaped valves are typically made of lead-containing metal. When such T-shaped valves are used for piping drinking water, water flows therethrough is likely to be contaminated by lead-containing metal substances leached from the T-shaped valves, risking users' health.

### SUMMARY OF THE INVENTION

In view of the foregoing shortcomings of the existing devices, the present invention herein provides a T-shaped valve, which is equipped with an improved fitting structure that facilitates installation, wherein components of the T-shaped valve are made of plastic instead of metal so as to prevent water flowing therethrough from metal contamination.

According to the present invention, a T-shaped valve primarily comprises: a connecting pipe and a branch pipe extending perpendicular to and communicating with the connecting pipe and carrying a control valve, the connecting pipe defining therein a channel ended with an inlet end and an outlet end, and the inlet end being provided with an improved fitting structure, wherein the fitting structure comprises: a receiving section of the connecting pipe defining a receiving portion at the inlet end of the channel; an adapter having one end fixed to an inner wall of the receiving portion and an opposite end peripherally formed with a flange; and a nut having one end internally formed with a peripheral stepped section for retaining the flange of the adapter such that the adapter is allowed to rotate with respect to the nut and having an opposite end internally formed with threads extending axially through the nut to the stepped section for coupling external threads of an external water source.

The primary objective of the present invention is that the T-shaped valve in virtue of the improved fitting structure can be properly installed without repeated adjustment and/or reinstallation.

Another objective of the present invention is that the components of the T-shaped valve are made of alternative material, such as plastic, instead of lead-containing metal, so the T-shaped valve ensures water quality.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a T-shaped valve according to one embodiment of the present invention;

FIG. 2 is an exploded view of the T-shaped valve of FIG. 1;

FIG. 3 is a cross-sectional view of the T-shaped valve of FIG. 1; and

FIG. 4 through FIG. 7 illustrate installation of the T-shaped valve of FIG. 1.

### DETAILED DESCRIPTION OF THE INVENTION

The following preferred embodiment when read with the accompanying drawings is made to clearly exhibit the above-mentioned and other technical contents, features and effects of the present invention. Through the exposition by means of the specific embodiment, people would further understand the technical means and effects the present invention adopts to achieve the above-indicated objectives. However, the accompanying drawings are intended for reference and illustration, but not to limit the present invention and are not made to scale.

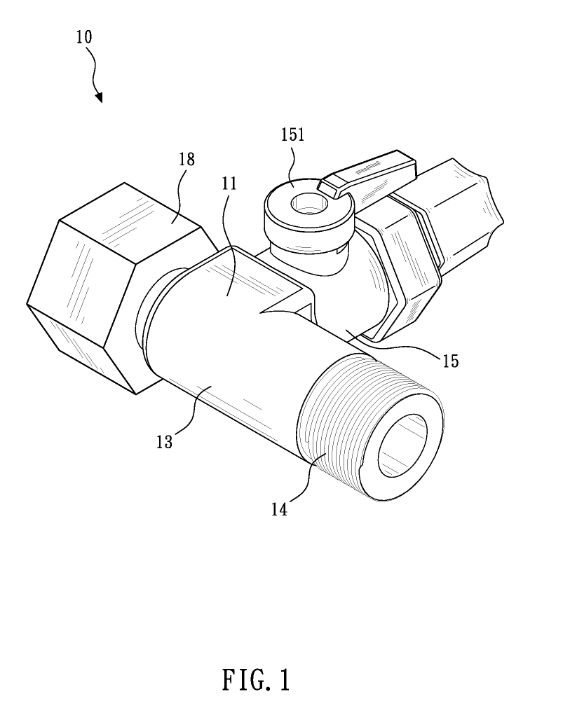

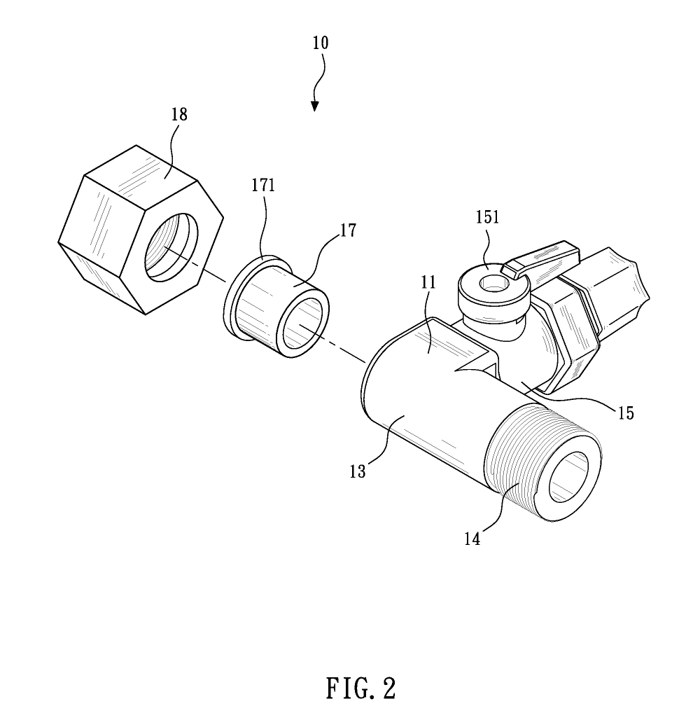

Referring to FIG. 1 through FIG. 3, a T-shaped valve 10 of the present invention includes a connecting pipe 11. The connecting pipe 11 may be made of plastic or a lead-free metal, and defines therein a channel 12. The connecting pipe 11 has an inlet end provided with an improved fitting structure and an outlet end 14 formed with external threads. The fitting structure is composed of a receiving section 13, an adapter 17 and a nut 18, which will be described in detail below. The T-shaped valve 10 also has a branch pipe 15 extending perpendicular to and communicating with the connecting pipe 11 and carrying a control valve 151. The channel 12 is ended with a receiving portion 16 corresponding to the receiving section 13. The receiving portion 16 receives the adapter 17, which may be also made of plastic. The adapter 17 is combined with an inner wall of the receiving portion 16 through thermal joining, such as ultrasonic joining. The nut 18 is mounted around the adapter 17. The adapter 17 has its end opposite to the end combined with the receiving portion 16 formed with a flange 171 to be rotatably retained by a peripheral stepped section 181 formed inside the nut 18. The nut 18 has its end opposite to the stepped section 181 formed with internal threads extending axially through the nut 18 to the stepped section 181 so that the nut 18 can engage an external water source or pipe joint with external threads.

With the foregoing configuration, operation of the present invention will be illustrated below.

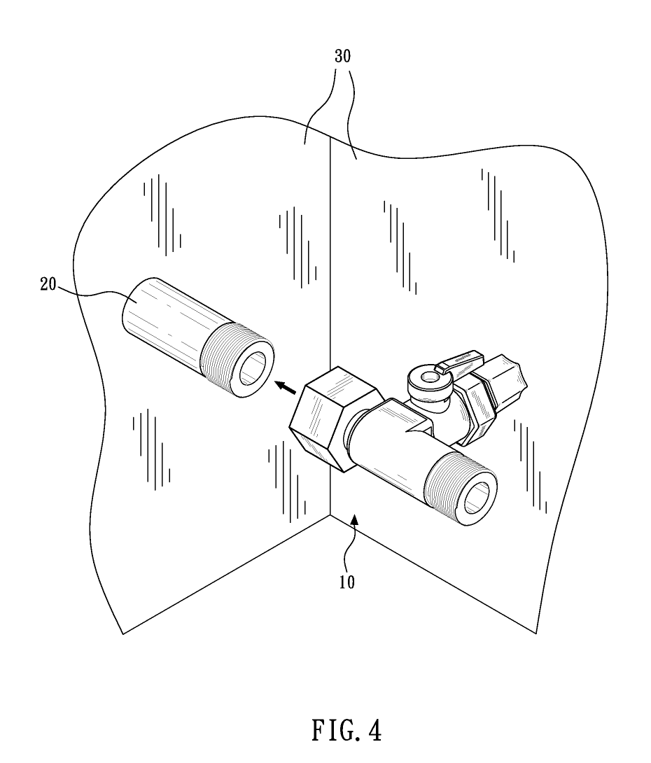

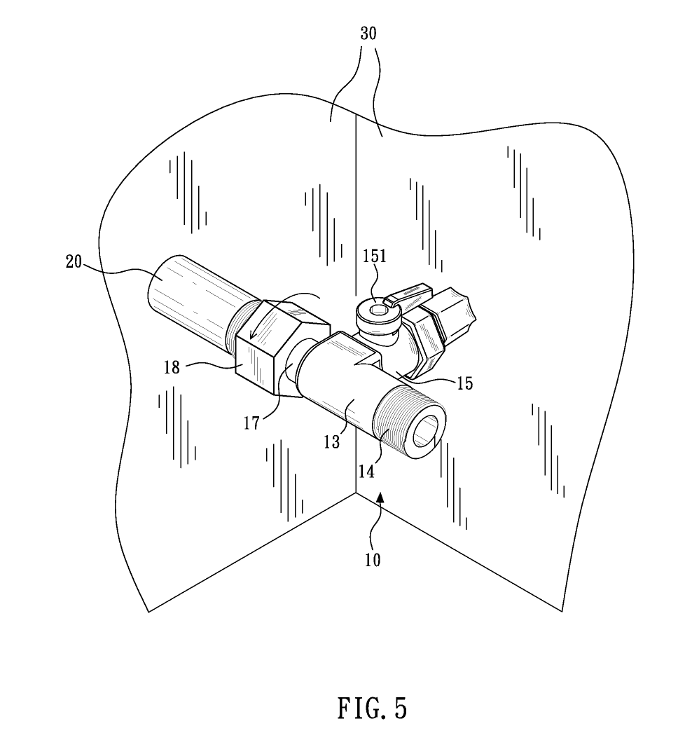

Referring to FIG. 4 and FIG. 5, for installation of the T-shaped valve 10 to a wall-fixed pipe 20 prefixed to a wall 30, the wall-fixed pipe 20 having external threads is first wound by tape seal, as performed in the installation of the prior-art device. Then, for assembling the T-shaped valve 10 to the wall-fixed pipe 20, the nut 18 of the T-shaped valve 10 is partially screwed onto the external threads of the wall-fixed pipe 20. In other words, the T-shaped valve 10 is not fully screwed to the external threads of the wall-fixed pipe 20. At this time, since the flange 171 of the adapter 17 is rotatably retained by the stepped section 181 of the nut 18, the adapter 17 is coaxially rotatable with respect to the nut 18 in a range of 360 degrees. Because the adapter 17 has its end fixedly received by the receiving portion 16 in the channel 12 of the connecting pipe 11, when the adapter 17 rotates, the connecting pipe 11 rotates simultaneously, thereby causing the branch pipe 15 as well as the control valve 151 to rotate until it gets properly oriented.

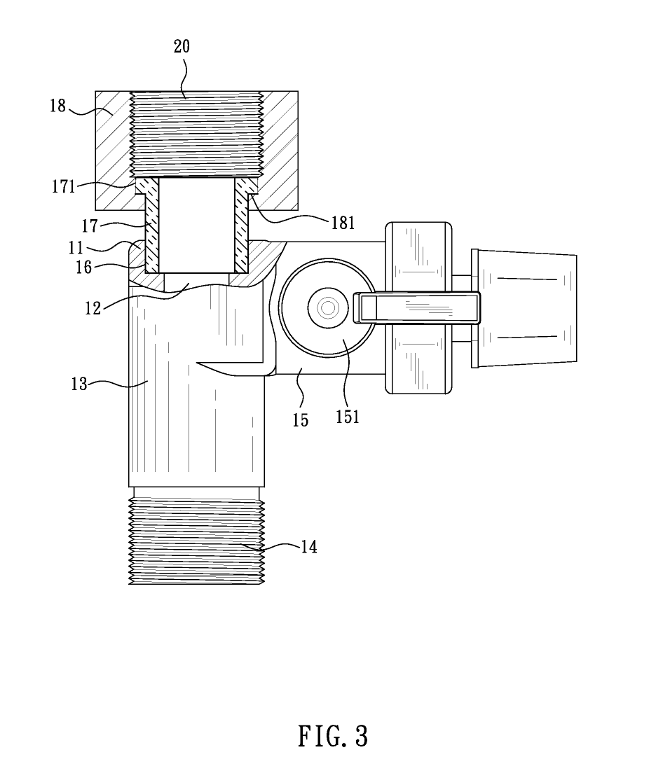

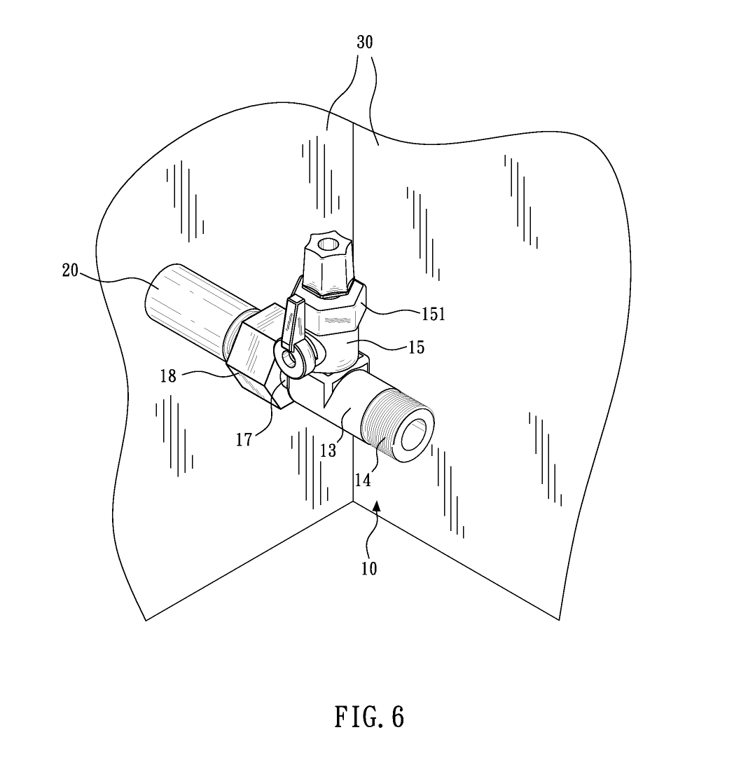

As shown in FIG. 6, after the branch pipe 15 and the control valve 151 are rotated to the proper orientation, the nut 18 is fully screwed into the wall-fixed pipe 20. In this process, the stepped section 181 of the nut 18 is pushing the flange 171 of the adapter 17 to the wall-fixed pipe 20 and the wall-fixed pipe 20 is pushing the flange 171 of the adapter 17 to the stepped section 181 of the nut 18 to the extent that the interface between the flange 171 and the wall-fixed pipe 20 receives axial pressures and therefore friction that prevent the flange 171 from rotating with respect to the nut 18 and the wall-fixed pipe 20 (as shown in FIG. 3). As a result, the control valve 151 can be positioned at the proper orientation no matter how the tape seal is arranged. Thereby, the installation has been conveniently accomplished.

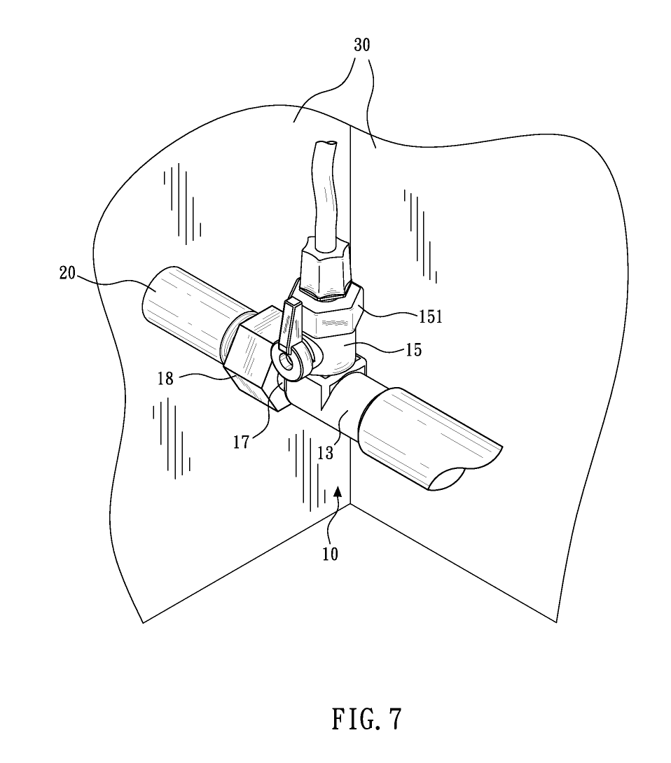

As shown in FIG. 7, after the T-shaped valve 10 is installed and the control valve 151 is properly oriented, an external water conduit may be attached to an outlet of the control valve 151, so that water can flow therethrough and enter an external water application. The outlet end 14 of the T-shaped valve 10 may be connected in a screwing manner with an extension pipe or another T-shaped valve for supplying water to more applications.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A T-shaped valve, comprising a connecting pipe and a branch pipe that extends perpendicular to and communicates with the connecting pipe and carries a control valve, the connecting pipe defining therein a channel terminated with an inlet end and an outlet end, and the inlet end being provided with an improved fitting structure, wherein the fitting structure comprises:
a receiving section of the connecting pipe defining a receiving portion at the inlet end of the channel;
an adapter having one end fixed to an inner wall of the receiving portion and an opposite end peripherally formed with a flange; and
a nut having one end internally formed with a peripheral stepped section for retaining the flange of the adapter within the nut such that the adapter is allowed to rotate with respect to the nut, and having an opposite end internally formed with threads extending axially through the nut to the stepped section for coupling external threads of an external water source.

2. The T-shaped valve of claim 1, wherein the connecting pipe is made of plastic.

3. The T-shaped valve of claim 1, wherein the adapter is made of plastic.

4. The T-shaped valve of claim 1, wherein the adapter is fixed to the inner wall of the receiving portion by means of ultrasonic joining.
